(19) United States
(12) Patent Application Publication
(10) Pub. No.: US 2022/0159393 A1
(43) Pub. Date: May 19, 2022

(54) METHOD FOR SUPPORTING THE USE OF A HEARING AID, AND HEARING AID

(71) Applicant: Sivantos Pte. Ltd., Singapore (SG)

(72) Inventor: Matthias Froehlich, Erlangen (DE)

(21) Appl. No.: 17/523,499

(22) Filed: Nov. 10, 2021

(30) Foreign Application Priority Data
Nov. 13, 2020 (DE) 10 2020 214 329.3

(51) Int. Cl. H04R 25/00

(52) U.S. Cl. CPC H04R 25/70; H04R 25/505

(57) ABSTRACT

A method for supporting the use of a hearing aid having a signal processing device for generating an output signal as a function of an input signal, includes suppressing noise in the input signal by using a digital filter. A first configuration for the digital filter is stored in the signal processing device, resulting in the digital filter having a first filtering effect, a second configuration for the digital filter is stored in the signal processing device, resulting in the digital filter having a second, reduced filtering effect. A triggerable time-controlled adaptation process is stored in the signal processing device. The first configuration is specified as a starting configuration and the adaptation process is executed after being triggered by the signal processing device, thereby transferring the configuration from the first configuration to the second configuration. A hearing aid configured to carry out the method is also provided.

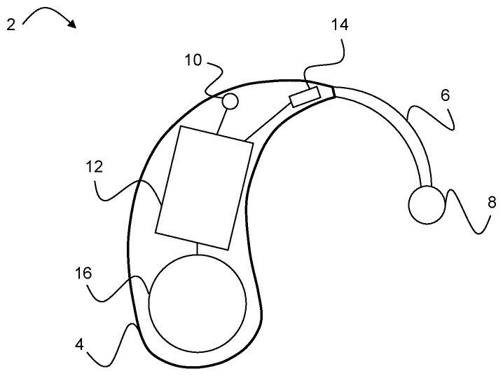

### CROSS-REFERENCE TO RELATED APPLICATION

This application claims the priority, under 35 U.S.C. § 119, of German Patent Application DE 10 2020 214 329.3, filed Nov. 13, 2020; the prior application is herewith incorporated by reference in its entirety.

### FIELD AND BACKGROUND OF THE INVENTION

The invention relates to a method for supporting the use of a hearing aid. It also relates to a corresponding hearing aid.

The designation hearing aids is commonly used to refer to classical hearing aids, the main function of which is to amplify acoustic signals. They are usually used to treat individuals with a hearing deficit due to a functional deficiency of the hearing organs, and in particular, for treating hearing impaired people.

Such hearing aids usually include the necessary components of at least an input transducer, a signal processing device, and an output transducer. The at least one input transducer is formed by an acousto-electric transducer, in particular by a microphone. The output transducer is an electro-acoustic transducer, typically a miniature speaker, also known as a “receiver”. In most cases, the signal processing device is implemented by an electronic circuit implemented on a circuit board. Independently thereof, the signal processing device includes an amplifier or is configured to implement an amplifier function.

In addition, hearing aids are often configured to implement a filter function for noise suppression in addition to an amplifier function. Relevant filter functions as well as hearing aids constructed for that purpose are generally known in principle and can be found in, for example, European Patent Application EP 3 565 270 A1, corresponding to U.S. Pat. No. 10,991,378; German Patent DE 10 2015 207 706 B3 corresponding to U.S. Pat. No. 9,877,118; and U.S. Patent Application Publication No. 2005/0256594 A1. Other examples of such filter functions can be found in “Dillon, Harvey: Hearing Aids, 2001, Thieme Publishers,” and in “Sandlin, Robert E.: Textbook of Hearing Aid Amplification, Second Edition, Singular Publishing Group.”

### SUMMARY OF THE INVENTION

It is accordingly an object of the invention to provide an advantageous method for supporting the use of a hearing aid and an advantageously configured hearing aid, which overcome the hereinafore-mentioned disadvantages of the heretofore-known methods and hearing aids of this general type.

With the foregoing and other objects in view there is provided, in accordance with the invention, a method for supporting the use of a hearing aid, which comprises providing a signal processing device for generating an output signal as a function of an input signal, in such a way that noise contained in the input signal is suppressed by using a digital filter, wherein:
a first configuration for the digital filter is stored in the signal processing device, as a result of which the digital filter has a first filtering effect,
a second configuration for the digital filter is stored in the signal processing device, as a result of which the digital filter has a second, reduced filtering effect,
a triggerable, time-controlled adaptation process is stored in the signal processing device,
the first configuration for the digital filter is specified as a starting configuration, and
the adaptation process is executed after being triggered by the signal processing device, thereby transferring the configuration of the digital filter from the first configuration to the second configuration.

With the objects of the invention in view, there is also provided a hearing aid configured for the method. Preferred extensions are specified in the cross-referenced claims. The advantages and preferred embodiments cited in relation to the method are also applicable mutatis mutandis to the hearing aid and vice versa.

The method according to the invention is used to support the use of a hearing aid, in particular a hearing aid of the type mentioned above. The hearing aid according to the invention, in turn, is configured for the method according to the invention or at least one of the method steps, and in particular for executing of at least one method step of the method according to the invention.

For this purpose, the hearing aid includes a signal processing device for generating an output signal as a function of an input signal, namely in such a way that noise contained in the input signal is suppressed by using a digital filter. This means that the signal processing device is configured for noise suppression.

Typically, in a standard or basic operating mode of the hearing aid, an electrical input signal is generated by using a microphone of the hearing aid as a function of an acoustic input signal, i.e. an acoustic signal from the environment of the hearing aid. This electrical input signal is then expediently fed to the signal processing device where the signal is first converted into a digital input signal. The digital input signal is then usually processed in a main processing process, from which a digital output signal is generated. The digital output signal is in turn expediently converted into an electrical output signal and typically finally converted into an acoustic output signal by using a loudspeaker of the hearing aid.

The acoustic output signal preferably represents a reproduction of the acoustic input signal in which at least individual frequency components are amplified relative to the acoustic input signal. Accordingly, in the main processing process, an amplifier function is applied to the digital input signal. In addition, however, a filter function, namely the above-mentioned digital filter, is also applied to the digital input signal, wherein the filter function is usually applied first, followed by the amplifier function. In this case, the filtering effect is used for noise suppression.

Methods in which a filter function for noise suppression is used in addition to an amplifier function, as well as hearing aids constructed for this purpose, are generally known from the prior art and can be found, for example, in European Patent Application EP 3 565 270 A1, corresponding to U.S. Pat. No. 10,991,378 or German Patent DE 10 2015 207 706 B3 corresponding to U.S. Pat. No. 9,877,118. Other examples of such filter functions can be found in “Dillon, Harvey: Hearing Aids, 2001, Thieme Publishers,” and in “Sandlin, Robert E.: Textbook of Hearing Aid Amplification, Second Edition, Singular Publishing Group.”

In the course of the method according to the invention for supporting the use of a hearing aid, i.e. the hearing aid according to the invention, a first configuration for the filter function or the digital filter is then stored in the signal processing device, as a result of which the digital filter has a first filtering effect. In addition, in the course of the method, a second configuration for the digital filter is stored in the signal processing device, as a result of which the digital filter has a second, reduced filtering effect. In this case, the reduced filtering effect expediently results in a weaker noise suppression in relation to the filtering effect of the first configuration, and/or at least a weaker suppression of selected frequency components in the signal that is processed with the filter function. In addition, in the course of the method a triggerable and time-controlled adaptation process is stored in the signal processing device. Also, the first configuration for the digital filter is specified as a starting configuration in the course of the method. If the adaptation process is then triggered, the adaptation process is subsequently executed by the signal processing device, i.e. in particular automatically, thereby transferring the configuration of the digital filter from the first configuration to the second configuration.

The first configuration for the digital filter is then specified in the signal processing device, in particular at the beginning of the adaptation process, and during the adaptation process the configuration for the digital filter is modified by the signal processing device continuously or gradually, i.e. in a specified number of steps, until at the end of the adaptation process the second configuration for the digital filter is specified in the signal processing device.

In this case, the adaptation process preferably carries out the adaptation while the hearing aid is being used by a hearing aid wearer who uses the hearing aid to compensate at least partially for a hearing deficit, namely their own hearing deficit. Furthermore, the adaptation preferably takes place in a familiarization period after the hearing aid is acquired, in which the hearing aid wearer becomes accustomed to the hearing aid. Through the use of the adaptation process, the hearing aid wearer is then preferably supported in becoming accustomed to and thus using the hearing aid. In this case, the adaptation process can also be referred to as an acclimatization process.

According to at least one variant of the method, the starting configuration is specified by the manufacturer. In this case, the hearing aid is typically pre-programmed and/or pre-set during or at the end of the manufacturing process of the hearing aid. This means that in particular, at least the first configuration is stored in the signal processing device during or at the end of the manufacturing process of the hearing aid. With the pre-programming or the pre-setting, which then also specifies the first configuration as the starting configuration for the digital filter, the hearing aid is then delivered to the sales outlet and/or to the end user. In addition, the triggerable and time-controlled adaptation process is also stored in the signal processing device during or at the end of the manufacturing process of the hearing aid, in particular by pre-programming and/or pre-setting the hearing aid. This means that the adaptation process is also preferably specified by the manufacturer.

It is also advantageous if, during the course of the method, a fitting session is carried out with the starting configuration, in which the hearing aid is adapted to the individual needs of a hearing aid wearer, in particular the above-mentioned hearing aid wearer. A corresponding fitting session is usually carried out by a hearing aid service provider such as an audiologist or hearing aid specialist, who then adapts the hearing aid to the individual needs of the hearing aid wearer. During the fitting, the service provider is typically also a user of the hearing aid, albeit only a temporary user. The hearing aid wearer, on the other hand, is the main user.

During the above-mentioned fitting session, the hearing aid is adapted to the individual needs of the hearing aid wearer. In this case, a previously described amplifier function of the hearing aid is preferably adapted to the individual needs of the hearing aid wearer, wherein the adaptation typically takes place based on a so-called audiogram which reflects the hearing deficit of the hearing aid wearer.

During a fitting of the hearing aid, described above and carried out by the above-mentioned service provider, the service provider typically also tests the auditory impression of the hearing aid. For example, the service provider listens in to the hearing aid before adapting it to the hearing loss or hearing deficit of the hearing aid wearer. The hearing aid is normally in the so-called delivery condition at the time. In some cases, in the delivery condition a slight default hearing loss is already programmed into the hearing aid at the factory. The service provider can also listen in to the hearing aid without having to connect it to some kind of adaptation software. It is also typically the case that the service provider tests the auditory impression with the configuration of the amplifier function adapted to the hearing deficit of the hearing aid wearer.

Irrespective of this, the auditory impression of the hearing aid is usually dependent on the hearing capacity of the user, for example the service provider who tests the hearing aid. In addition, the auditory impression of the hearing aid is usually dependent on the configuration of the filter function, i.e. the digital filter. The first configuration, which is preferably used as a starting configuration during the fitting session, is then ideally selected in such a way that a particularly good auditory impression is conveyed to a user without a hearing deficit, in particular to the service provider. Therefore, a user without a hearing deficit, and in particular the service provider, is supported by the starting configuration in their use of the hearing aid, in particular during an above-mentioned fitting session, and thus also the user without a hearing deficit or the service provider is supported in the use of the hearing aid by the method according to the invention. The user without a hearing deficit, in particular, perceives a positive auditory impression when the digital filter provides a strong noise suppression. Therefore, the first configuration preferably takes such a form that with the first configuration the digital filter has a strong filtering effect, or at least a stronger filtering effect than with the second configuration. Thus, the digital filter then causes a stronger noise suppression in the first configuration than in the second configuration.

A user with a hearing deficit, i.e. in particular the hearing aid wearer, would not perceive or at least less clearly perceive the noise due to their hearing deficit if no noise suppression was carried out, which is why the user does not benefit, or at least benefits less, from a strong noise suppression. Therefore, the second configuration is preferably chosen in such a way that a particularly good auditory impression is conveyed to a user with a hearing deficit, in particular to the hearing aid wearer. For this purpose, the second configuration preferably takes such a form that the digital filter with the second configuration has a weak filtering effect or at least a reduced filtering effect compared to the filter effect of the first configuration. In addition, the second configuration is then also beneficial for the user with a hearing deficit, in particular for the hearing aid wearer, since as is well known a corresponding filter function not only suppresses unwanted noise, but also filters out other signal components. As a rule, a (strong) noise reduction also has a negative effect, for example on speech intelligibility. This negative effect is typically weaker with weaker noise suppression and for this reason, the second configuration with the second reduced filtering effect is advantageous for the user with a hearing deficit since the second configuration typically results in better speech intelligibility.

As explained, in the course of the method a previously described fitting session is preferably carried out with the starting configuration. During the fitting session, a previously described amplifier function of the signal processing device is further preferably adapted to the individual needs of the hearing aid wearer, i.e. the main user, with the adaptation being typically based on a so-called audiogram. At least, however, the amplifier function is typically adapted in accordance with the hearing deficit of the hearing aid wearer, which is caused by a functional deficiency of the hearing organs of the hearing aid wearer. At the conclusion of such a fitting session, according to at least one embodiment variant of the method according to the invention, the adaptation process is then triggered or started, for example by a start command being input into the hearing aid, in particular by the service provider.

According to an alternative method variant the adaptation process is triggered, in particular automatically, after a specified period of wearing the hearing aid, during which the hearing aid wearer uses the hearing aid. For this purpose, for example, when the hearing aid is switched on for the first time, a countdown or a timer or a counter is activated, which then triggers or starts the adaptation process automatically after a specified time period. According to a further solution variant, the wearing period in the hearing aid is determined from the charging state of a rechargeable battery in the hearing aid or from the residual charge of a battery of the hearing aid. Also expedient is a solution variant in which the wearing period is determined by a mobile data processing device, such as a smartphone. For this purpose, the mobile data processing unit is preferably at least intermittently coupled to the hearing aid, in particular for the purpose of data transfer.

Also typical is a method variant in which the adaptation process extends over more than two days and, in particular, more than two weeks. The adaptation is also preferably carried out in such a way that the filtering effect of the digital filter is gradually reduced over a fairly long period of time. A linear reduction, for example, is suitable for this purpose. Furthermore, the reduction is usually carried out in a series of discrete steps, with typically at least five steps being provided, in particular more than ten. According to one structural variant, the filtering effect is reduced by one step every 24 hours, preferably over at least ten and more preferably over at least 20 days.

It is also favorable if the reduced filtering effect of the digital filter in the second configuration is limited to a specified frequency range. This means that the second filtering effect in the specified frequency range is reduced compared to the first filtering effect in this frequency range. Outside this specified frequency range, however, the filtering effect of the digital filter in the second configuration is preferably similar to or exactly the same as the filtering effect of the digital filter in the first configuration.

The specified frequency range used is preferably specified in a fitting session, in particular in a previously mentioned fitting session, by specifying an individual frequency range. In this case, the second configuration is stored in the signal processing device in the fitting session or adapted by at least specifying an individual frequency range.

The individual frequency range is also preferably dependent on the main user, i.e. the hearing aid wearer, wherein the individual frequency range advantageously extends over a frequency range which is covered by the hearing deficit of the hearing aid wearer.

Other features which are considered as characteristic for the invention are set forth in the appended claims.

Although the invention is illustrated and described herein as embodied in a method for supporting the use of a hearing aid and a hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE FIGURE

The FIGURE of the drawing is a schematic, cross-sectional view of a hearing aid.

### DETAILED DESCRIPTION OF THE INVENTION

Referring now in detail to the single FIGURE of the drawing, there is seen a hearing aid 2, which is described in the following example, shown schematically and constructed as a so-called BTE hearing aid. The hearing aid 2 includes a BTE housing 4, which is constructed for wearing behind an ear of a non-illustrated user, in particular of a hearing aid wearer, of the hearing aid 2. An acoustic output signal generated within the BTE housing 4 is routed, through a sound tube 6 connected to the BTE housing 4, to an earpiece 8. The acoustic output signal is then coupled through the earpiece 8 into the user's ear.

Also disposed within the BTE housing 4 are a microphone 10 as an acousto-electric input transducer, a signal processing device 12, a loudspeaker 14 as an electro-acoustic output transducer, and a rechargeable battery 16 or a battery.

The hearing aid 2 constructed in this way is configured, when operated in a basic operating mode, to generate an electrical input signal by using the microphone 10 of the hearing aid 2 as a function of an acoustic input signal, i.e. an acoustic signal from the environment of the hearing aid 2. This electrical input signal is then expediently fed to the signal processing device 12 where the signal is first converted into a digital input signal. The digital input signal is then usually processed in a main processing process, from which a digital output signal is generated. The digital output signal in turn is converted into an electrical output signal and finally converted into an acoustic output signal by using the loudspeaker 14 of the hearing aid 2.

The acoustic output signal preferably represents a reproduction of the acoustic input signal, in which at least individual frequency components are amplified relative to the acoustic input signal. Accordingly, in the main processing process, an amplifier function is applied to the digital input signal. In addition, however, a filter function in the form of a digital filter is also applied to the digital input signal, wherein the filter function is usually applied first, followed by the amplifier function. In this case the filtering effect and hence the digital filter is aimed at noise suppression.

In order to support the use of the hearing aid 2, the non-illustrated manufacturer of the hearing aid 2 also stores a first configuration for the filter function or the digital filter in the signal processing device, as a result of which the digital filter has a first filtering effect. In addition, the manufacturer stores a second configuration for the digital filter in the signal processing device, as a result of which the digital filter has a second, reduced filtering effect. In this case, in relation to the filtering effect of the first configuration, the reduced filtering effect produces a weaker noise suppression and/or at least a weaker suppression of selected frequency components in the signal that is processed with the filter function. In addition, a triggerable and time-controlled adaptation process is stored in the signal processing device by the manufacturer. Furthermore, the first configuration for the digital filter is specified as a starting configuration. All of this is usually carried out at the end of the manufacturing process of the hearing aid 2.

For such a hearing aid 2, it is also provided that after the purchase of the hearing aid 2 by the hearing aid holder, a fitting session is carried out, in which the hearing aid 2 is adapted to the individual needs of the non-illustrated hearing aid wearer. This fitting session is carried out with the starting configuration, which is beneficial for such a fitting session.

A corresponding fitting session is usually carried out by a non-illustrated hearing aid service provider, such as an audiologist or hearing aid specialist. During the fitting, the service provider is also a user of the hearing aid 2, albeit only a temporary user. The hearing aid wearer, on the other hand, is the main user. In the course of the fitting session, the previously described amplifier function of the hearing aid 2 is also typically adapted to the individual needs of the hearing aid wearer, with the adaptation being typically carried out based on a so-called audiogram which reflects the hearing deficit of the hearing aid wearer.

At the end of such a fitting session, the adaptation process is then triggered or started, for example by the service provider inputting a start command into the hearing aid. Alternatively, the adaptation process is triggered automatically after a specified period of, for example, five days of wearing the hearing aid 2, during which the hearing aid holder uses the hearing aid 2. For this purpose, for example, when the hearing aid 2 is switched on for the first time, a countdown is activated which then finally triggers or starts the adaptation process automatically after the specified time period, i.e. the specified wearing period.

After being triggered, the stored adaptation process is executed by the signal processing device, thereby automatically transferring the configuration of the digital filter from the first configuration to the second configuration. The adaptation process also extends over four weeks, for example. The adaptation is carried out in such a way that the filtering effect of the digital filter is gradually reduced. For this purpose, the reduction takes place in a series of discrete steps, wherein in the exemplary embodiment 28 stages are provided. In this case the filtering effect is reduced by one step every 24 hours.

The following is a summary list of reference numerals and the corresponding structure used in the above description of the invention:
2 hearing aid, BTE hearing aid
4 BTE housing/hearing aid housing
6 sound tube
8 earpiece
10 microphone
12 signal processing device
14 loudspeaker
16 rechargeable battery

1. A method for supporting the use of a hearing aid, the method comprising:
providing a hearing aid including a signal processing device for generating an output signal as a function of an input signal and suppressing noise contained in the input signal by using a digital filter;
storing a first configuration for the digital filter in the signal processing device, resulting in the digital filter having a first filtering effect;
storing a second configuration for the digital filter in the signal processing device, resulting in the digital filter having a second, reduced filtering effect;
storing a triggerable, time-controlled adaptation process in the signal processing device;
specifying the first configuration for the digital filter as a starting configuration; and
executing the adaptation process after being triggered by the signal processing device, thereby transferring the configuration of the digital filter from the first configuration to the second configuration.

2. The method according to claim 1, which further comprises specifying the starting configuration by the manufacturer.

3. The method according to claim 1, which further comprises carrying out a fitting session with the starting configuration, and adapting the hearing aid to individual needs of a hearing aid wearer during the fitting session.

4. The method according to claim 1, which further comprises carrying out a fitting session with the starting configuration, and adapting an amplifier function of the signal processing device to individual needs of a hearing aid wearer during the fitting session.

5. The method according to claim 3, which further comprises triggering the adaptation process at an end of the fitting session.

6. The method according to claim 4, which further comprises triggering the adaptation process at an end of the fitting session.

7. The method according to claim 1, which further comprises triggering the adaptation process after a specified wearing period of the hearing aid.

8. The method according to claim 1, which further comprises extending the adaptation process over more than two days.

9. The method according to claim 1, which further comprises extending the adaptation process over more than two weeks.

10. The method according to claim 1, which further comprises limiting the reduced filtering effect of the digital filter in the second configuration to a specified frequency range.

11. The method according to claim 1, which further comprises adapting the second configuration in a fitting session by specifying an individual frequency range, for limiting the reduced filtering effect to the individual frequency range.

12. The method according to claim 11, which further comprises specifying the individual frequency range as a frequency range being covered by a hearing deficit of a hearing aid wearer.

13. A hearing aid, comprising a signal processing device configured to carry out the method according to claim 1.
